(19) United States
(12) Patent Application Publication
(10) Pub. No.: US 2005/0043990 A1
(43) Pub. Date: Feb. 24, 2005

(54) Method and system for processing and managing referral data

(76) Inventor: Jason Dean Powers, Santa Monica, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/642,843

(22) Filed: Aug. 18, 2003

(51) Int. Cl. G06F 17/60

(52) U.S. Cl. 705/14; 705/10

(57) ABSTRACT

A method and system for processing and managing referral data are disclosed. The system comprises a business rules engine for applying at least one business rule to referral data associated with a business entity. Further, the system has a data store for storing the referral data. Moreover, the system includes a reporting and pattern analyzer for analyzing the referral data and for generating reports about the referral data. Furthermore, the system includes a notification and alert system for generating an alert to the business entity, wherein the alert is based on a plurality of criteria associated with the referral data.

### BACKGROUND OF THE INVENTION

1. Field of the Invention

The present invention generally relates to data processing and management. More particularly, the present invention relates to processing and managing referral data.

2. Related Art

A business entity generates much data in its dealings with customers. The customer may purchase a product or use a service offered by the business entity. From its experience with the business entity, the customer may provide the business entity some referral data either directly or indirectly.

This referral data can benefit the business entity if the referral data is efficiently utilized. Unfortunately, the business entity tends to manually process and manage the referral data. Moreover, conventional systems intended to manage this referral data are not integrated with the system that interface with the customer, leading to an uncoordinated management of this referral data. Additional, these conventional systems are hard to use and operate.

### SUMMARY OF THE INVENTION

A method and system for processing and managing referral data are disclosed. The system comprises a business rules engine for applying at least one business rule to referral data associated with a business entity. Further, the system has a data store for storing the referral data. Moreover, the system includes a reporting and pattern analyzer for analyzing the referral data and for generating reports about the referral data. Furthermore, the system includes a notification and alert system for generating an alert to the business entity, wherein the alert is based on a plurality of criteria associated with the referral data.

### BRIEF DESCRIPTION OF THE DRAWINGS

The accompanying drawings, which are incorporated in and form a part of this specification, illustrate embodiments of the invention and, together with the description, serve to explain the principles of the present invention.

FIG. 1 illustrates a system in accordance with an embodiment of the present invention.

FIG. 2 illustrates a direct referral scenario in accordance with an embodiment of the present invention.

FIG. 3 illustrates an indirect referral scenario in accordance with an embodiment of the present invention.

### DETAILED DESCRIPTION OF THE INVENTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention.

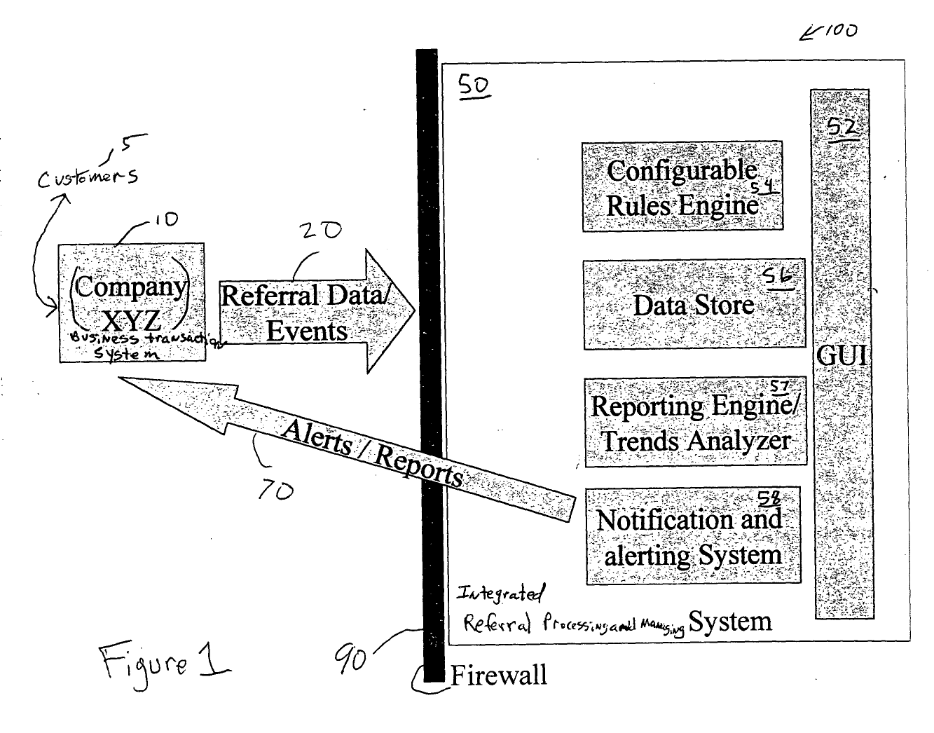

FIG. 1 illustrates a system 100 in accordance with an embodiment of the present invention. The system 100 includes a business transaction system 10 of a business entity (e.g., company XYZ) and an integrated referral processing and managing system (IRPM) 50. In one embodiment, the business transaction system 10 and the IRPM 50 are located at different sites. Hence, the business transaction system 10 and the IRPM 50 communicate and interface via a network (not shown). A firewall 90 may be utilized to protect the business transaction system 10 and the IRPM 50. In another embodiment the business transaction system 10 and the IRPM 50 are located at same site (e.g., location of business entity).

The business transaction system 10 interacts with customers 5. These customers may be purchasing a product offered by the business entity or may use a service offered by the business entity. As a result, the business transaction system 10 generates a plurality of transaction data. This transaction data includes referral data 20. Referral data 20 can include occurrence of a referral event, the customer that made the referral (e.g., referrer), who was the target of the referral (e.g., referree), and how the referree reacted to the referral. The business transaction system 10 is configured to send the referral data 20 to the IRPM 50. The business transaction system 10 can be implemented in hardware, software, or a combination thereof.

The integrated referral processing and managing system (IRPM) 50 includes a configurable business rules engine 54, a data store 56, a reporting and trends/pattern analyzer 57, a notification and alert system 58, and a graphical user interface (GUI) 52. The IRPM 50 interfaces with the business transaction system 10 in order to centrally monitor, process, and manage the customer referrals and customer feedback about the referrals. The IRPM 50 can be implemented in hardware, software, or a combination thereof. The IRPM 50 provides integration, ease of use, consolidation, and coordination in monitoring, processing, and managing referral data 20.

The data store 56 stores the referral data 20. Moreover, a full history of a particular referral can be captured in the data store 56. Besides the referral data 20 described above, the referral data 20 can further include whether the referree purchased the product or service offered by the business entity, when was this transaction, how much was purchased, whether the referree also refer other people to the business entity, how did those other people respond to the referral, etc.

The configurable business rules engine 54 applies one or more business rules to the referral data 20 received from the business transaction system 10. Examples of business rules include offer a 10% discount voucher to the referree, offer a 20% discount voucher to the referrer if the referrer provided 5 referrees within a month, and offer 10% discount voucher to referrer if referree purchases the product or uses the service offered by the business entity. The business rules can be changed and modified to meet the product/service promotional goals of the business entity.

The graphical user interface (GUI) 52 enables user-friendly operation and configuration of the IRPM 50.

The reporting and trends/pattern analyzer 57 can analyze the referral data and generate reports about the referral data 20 that can be sent to the business entity. Thus, this provides the capability to quality rate each referral and to analyze patterns of customer behavior and circumstances that lead to better quality referrals, whereas a quality referral refers to a referral that leads to a purchase or use of product/service offered by the business entity. Hence, the business entity is provided more intelligent analysis of customer behavior, quality of referrals, and what correlation there was between customer satisfaction and referrals given. Moreover, the business entity can such questions as what products/services prompted most referrals, what are the customer profiles of those which provided either successful referrals or unsuccessful referrals, and what incentives/levels of incentives worked/did not work to successfully promote referrals.

The notification and alert system 58 generates an alert 70 to the business entity. The notification and alert system 58 can also send out the reports about the referral data 20 (from the reporting and trends/pattern analyzer 57) to the business entity. The alert 70 can be based on a minimum referral threshold event, a referral quality threshold event, and a discount voucher qualification alert based on the business rule. Hence, the business entity can adjust a product/service promotion based on the alert 70. This enables an immediate response to trends and patterns in the referral data 20. Moreover, new product/service promotions can be designed based on the alert 70.

In practice, the referral data 20 associated with a business entity is received by the IRPM 50. Thereafter, the configurable business rules engine 54 applies at least one business rule to the referral data 20. Moreover, the referral data 20 is stored in the data store 56. Thus, the reporting and trends/pattern analyzer 57 can analyze the referral data 20 stored in the data store 56. Finally, the notification and alert system 58 generates an alert 70 to the business entity, whereas the alert 70 is based on a plurality of criteria associated with the referral data.

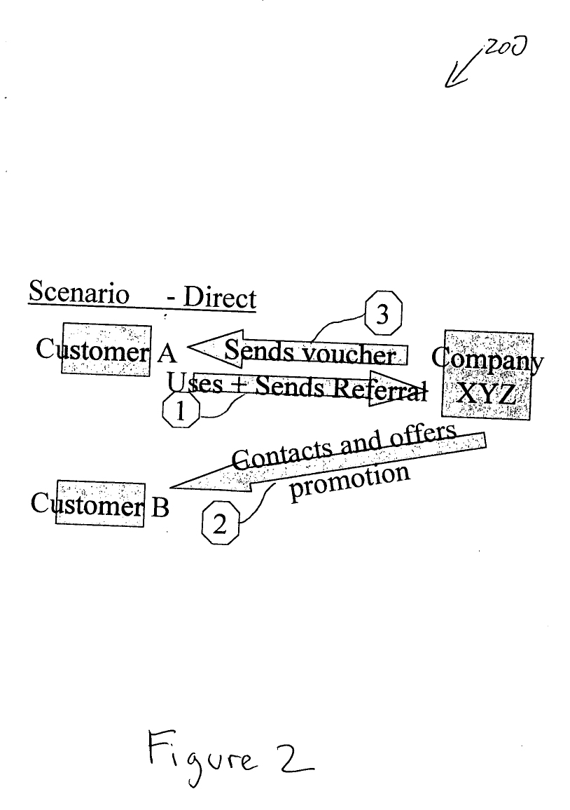

FIG. 2 illustrates a direct referral scenario 200 in accordance with an embodiment of the present invention. As depicted in FIG. 2, at arrow 1, customer A purchases or uses the product/service offered by the business entity (e.g., Company XYZ). Moreover, the customer A sends a referral to Company XYZ. Hence, customer A is a referrer. The Company XYZ sends the referral to the IRPM 50. The IRPM 50 then sends a first alert based on the results of the configurable business rules engine 54.

At arrow 2, based on the first alert, the Company XYZ contacts customer B and offers a discount voucher (based on the business rules set by Company XYZ) as a promotion. Customer B is a referree. Moreover, the IRPM 50 sends a second alert based on the results of the configurable business rules engine 54.

At arrow 3, based on the second alert, Company XYZ sends a discount voucher (based on the business rules set by Company XYZ) to customer A.

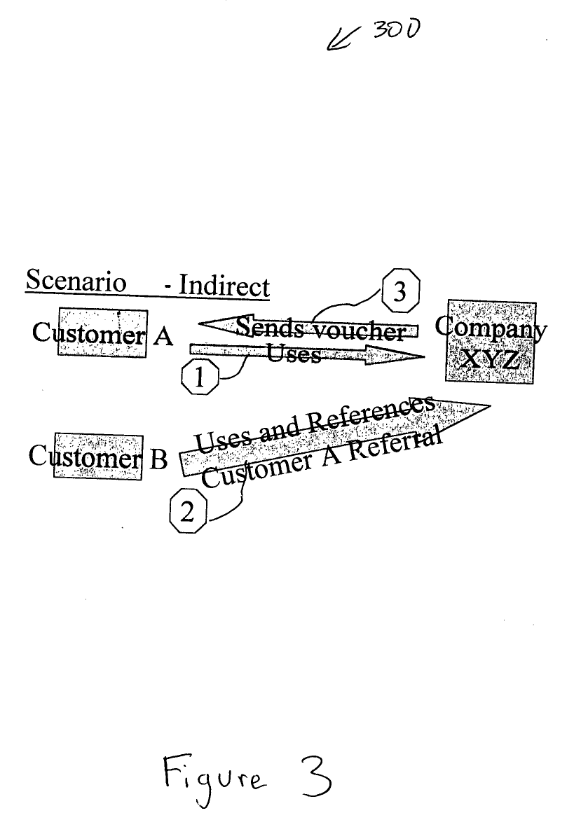

FIG. 3 illustrates an indirect referral scenario 300 in accordance with an embodiment of the present invention. As depicted in FIG. 3, at arrow 1, customer A purchases or uses the product/service offered by the business entity (e.g., Company XYZ).

At arrow 2, customer B purchases or uses the product/service offered by the business entity (e.g., Company XYZ). Moreover, the customer B references customer A as the person that referred customer B to Company XYZ. Hence, customer A is a referrer. Customer B is a referree. The Company XYZ sends the referral to the IRPM 50. Moreover, the IRPM 50 sends a first alert based on the results of the configurable business rules engine 54.

At arrow 3, based on the first alert, Company XYZ sends a discount voucher (based on the business rules set by Company XYZ) to customer A.

It should be understood that other referral scenarios are possible.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. An integrated referral processing and managing system comprising:
a business rules engine for applying at least one business rule to referral data associated with a business entity;
a data store for storing said referral data;
a reporting and pattern analyzer for analyzing said referral data and for generating reports about said referral data; and
a notification and alert system for generating an alert to said business entity, wherein said alert is based on a plurality of criteria associated with said referral data.

2. The system as recited in claim 1 further comprising a graphical user interface.

3. The system as recited in claim 1 wherein said referral data includes referral event data, referrer data, and referree data.

4. The system as recited in claim 1 wherein said business rule controls offering a discount voucher.

5. The system as recited in claim 1 wherein said criteria includes a minimum referral threshold event, a referral quality threshold event, and a discount voucher qualification alert based on said business rule.

6. The system as recited in claim 1 wherein said business entity receives said alert and adjusts a promotion based on said alert.

7. The system as recited in claim 1 wherein said referral data arises from business transactions between said business entity and a plurality of customers.

8. A system comprising:
an integrated referral processing and managing system including:
a business rules engine for applying at least one business rule to referral data associated with a business entity;
a data store for storing said referral data;
a reporting and pattern analyzer for analyzing said referral data and for generating reports about said referral data; and
a notification and alert system for generating an alert to said business entity, wherein said alert is based on a plurality of criteria associated with said referral data; and
a business transaction system for generating transaction data including said referral data and for sending said referral data to said integrated referral processing and managing system.

9. The system as recited in claim 8 wherein said integrated referral processing and managing system further comprises a graphical user interface.

10. The system as recited in claim 8 wherein said referral data includes referral event data, referrer data, and referree data.

11. The system as recited in claim 8 wherein said business rule controls offering a discount voucher.

12. The system as recited in claim 8 wherein said criteria includes a minimum referral threshold event, a referral quality threshold event, and a discount voucher qualification alert based on said business rule.

13. The system as recited in claim 8 wherein said business entity receives said alert and adjusts a promotion based on said alert.

14. The system as recited in claim 8 wherein said referral data arises from business transactions between said business entity and a plurality of customers.

15. A method of processing and managing referral data, said method comprising:
receiving said referral data associated with a business entity;
applying at least one business rule to said referral data;
storing said referral data;
analyzing said referral data; and
generating an alert to said business entity, wherein said alert is based on a plurality of criteria associated with said referral data

16. The method as recited in claim 15 wherein said referral data includes referral event data, referrer data, and referree data.

17. The method as recited in claim 15 wherein said business rule controls offering a discount voucher.

18. The method as recited in claim 15 wherein said criteria includes a minimum referral threshold event, a referral quality threshold event, and a discount voucher qualification alert based on said business rule.

19. The method as recited in claim 15 wherein said business entity receives said alert and adjusts a promotion based on said alert.

20. The method as recited in claim 15 wherein said referral data arises from business transactions between said business entity and a plurality of customers.
